(19) United States
(12) Patent Application Publication
(10) Pub. No.: US 2025/0282897 A1
(43) Pub. Date: Sep. 11, 2025

(54) PROCESS FOR MAKING A SOLID CATALYST COMPONENT FOR ETHYLENE POLYMERIZATION AND CO-POLYMERIZATION WITH HIGH ACTIVITY AND IMPROVED REACTOR OPERABILITY

(71) Applicant: Formosa Plastics Corporation, U.S.A., Livingston, NJ (US)

(72) Inventors: Gapgoung KONG, Sugarland, TX (US); Cyrus C.Y. LEE, Victoria, TX (US); Chih-Jian CHEN, Port Lavaca, TX (US)

(21) Appl. No.: 18/597,519

(22) Filed: Mar. 6, 2024

(51) Int. Cl. C08F 10/02

(52) U.S. Cl. CPC C08F 10/02

(57) ABSTRACT

A process for preparing a solid catalyst component containing Mg, Ti, and an internal electron donor formed in-situ is provided. The solid catalyst component is suitable for producing polyethylene and its copolymers, and said process shows a combination of high productivity and high bulk density of ethylene polymers, lower soluble fraction, uniform particle morphology, and adjustable control of molecular weight distribution to allow controlled improvement in product properties as per specific requirements.

### BACKGROUND

The present invention relates to a method for preparing a supported catalyst useful for producing polyethylene with improved activity and reactor operability, a supported catalyst prepared by the disclosed method having improved hydrogen response and bulk density and comonomer response for producing polyethylene, including high density polyethylene (HDPE), medium density polyethylene (MDPE), to linear low density polyethylene (LLDPE).

Polyethylene polymers are well known and useful in many applications. In the polyethylene industry, linear polyethylene polymers, from linear low density polyethylene (LLDPE) to medium or higher density polyethylene (MDPE or HDPE) are used in a wide variety of applications including film forming, injection molding, rotomolding, and wire and cable fabrication. As compared with counterpart LDPE resins, such linear polyethylene polymers typically exhibit enhanced high dart impact, increased Elmendorf tear, boosted tensile strength and enriched elongation in both the machine direction (MD) and the transverse direction (TD).

Ziegler-Natta type catalyst systems for the polymerization of ethylene and other olefins are well known in the art, as illustrated by U.S. Pat. No. 3,113,115. Ziegler-Natta type catalysts are particularly useful for producing polyethylene polymers in both a slurry process and a gas phase process. Advanced Ziegler-Natta catalysts based on supported titanium systems have received industrial interest for producing high performance polyethylene resins. Examples of such catalyst systems are described in U.S. Pat. Nos. 4,105,585; 5,047,468; 5,091,363; 5,192,731; 5,260,245; 5,336,652; 5,561,091; 5,561,091; and 5,633,419; and in European Patent Applications EP 0529977, EP 0336545, and EP 0703246, each of which is incorporated herein by reference in its entirety. The catalyst process disclosed in prior art references includes titanium compounds incorporated onto a suitable carrier (support) by impregnating this porous carrier with catalyst precursor solution (e.g. silica-supported catalyst system), with that supported titanium catalyst prepared by a one step (“in situ”) preparation process in which catalyst components or precursor are co-precipitated on a MgCl₂-based composite support during the catalyst process via the reaction of metal Mg with BuCl or a spray drying process.

As an example of such Ziegler-Natta type catalyst systems and their preparation methods, a catalyst system and its preparation method have been disclosed in which dialkylmagnesium and silane compounds are reacted with an —OH group on a silica support which is then contacted with a transition metal halide to form a relatively homogeneous active site. This silica supported catalyst system exhibits more homogeneous ethylene polymerization or co-polymerization capability than the previously discussed magnesium-based supported titanium halide catalyst systems as measured by resin MWD and compositional distribution. However, such catalyst systems require extra processing steps because the silica support must be treated, either chemically or thermally, to remove bound water and excess —OH groups prior to the formation of the catalyst. U.S. Pat. No. 5,561,091 discloses a process for obtaining polyethylene with a narrow molecular weight distribution by employing the steps of (i) contacting a solid, porous carrier having reactive hydroxyl (OH) groups in a non-polar liquid with dialkylmagnesium to form a product; (ii) introducing into the liquid containing said product of step (i) a mixture of SiCl₄ and an alcohol to form a slurry; and (iii) contacting the slurry of step (ii) with a transition metal compound selected from the group of titanium tetrachloride, titanium alkoxides, vanadium halides and vanadium alkoxides in a non-polar liquid medium to form a catalyst precursor, the transition metal compound being used in excess of the number of moles of hydroxyl groups on said carrier prior to reaction with dialkylmagnesium.

Additionally, catalyst systems have been disclosed in which dialkylmagnesium compounds are impregnated into a silica support containing —OH groups to form a first reaction product. The first reaction product is then halogenated with HCl to convert the organomagnesium derived compound to MgCl₂ thereby forming a second reaction product. The second reaction product is then treated with a transition metal halide such as TiCl₄, a particular type of electron donor, and at least one Group 2 or 13 organometallic compounds, such as diethylaluminum chloride. The multi-step process of this catalyst preparation is complicated and is a difficult process to control catalyst quality consistency.

Other supported titanium catalyst systems for polyethylene (HDPE or LLDPE) are obtained by dissolving MgCl₂ with [TiCl₃(AlCl₃)_{1/3}] in tetrahydrofuran (THF) to make a solution containing MgCl₂ and titanium halide that is subsequently immobilized on a silica support via spray drying process. However, the preparation of such catalyst systems often requires complicated processing steps including spray drier system and THF solvent circulation. The ratio of THF to Ti will affect catalyst quality during the process, which will be potential catalyst quality control issue from batch to batch. The polyethylene produced by using this catalyst system does not possess the narrow molecular weight distribution and the compositional distribution required for high performance resins.

Unlike the catalyst preparation method described above, a simple process to prepare supported Ziegler-Natta type catalyst was disclosed in French Patent No. 2,116,698 and European Patent EP 0529977. The catalyst was prepared in-situ by reacting magnesium metal with at least one halogenated hydrocarbon and at least one tetravalent titanium compound. Specifically, reacting magnesium metal powder with butyl chloride in a non-polar solvent in the presence of TiCl₄/Ti(OR)₄ in-situ forms a solid catalyst by one step reaction for gas phase ethylene co-polymerization. This method for producing catalyst was a simple process and provided a catalyst having uniform contribution of active species on the support. This method utilized an in-situ process whereby a transition metal is deposited on the support during the reaction that generates the support. In the prior art catalyst components, silicon-containing compounds were used to prepare or modify a MgCl₂ or silicon support, and then the transition metal was deposited on the support after the reducing power of the silicon-containing compounds had been used up.

However, the catalyst prepared by this method, by in-situ reacting magnesium metal with at least one halogenated hydrocarbon and at least one tetravalent titanium compound, shows broad particle size distribution, lower bulk density, poor morphology and operability for producing lower density resins, and inferior comonomer incorporation. In the gas phase process this catalyst composition produced polyethylene polymer with higher electric static and higher extractable fraction, which results in resin stickiness, chunk formation, and reactor fouling at economically favorable production rates. Such fouling may include polymer agglomeration, sheeting, or chunking, and may ultimately require reactor shut down. In addition, the catalyst prepared by this method demonstrated low activity for ethylene homopolymerization in the slurry process, due to over reduction of titanium active species. The HDPE resins obtained using such catalysts not only have a broader molecular weight distribution but also have high extractables and poor powder flow ability, which limit its application in a slurry bimodal process for pipe production.

In summary, the preparation of Ziegler-Natta catalysts for the catalytic control of molecular weight or composition branching distribution and catalyst morphology has heretofore required the complicated control of the active site formation process and careful tuning of the catalyst precipitation process to ensure formation of uniform catalyst active sites and consistent catalyst properties. Deteriorated catalyst properties are often present in the absence of control over the precipitation process, especially in multi-step processes.

Therefore, there is a continuing need for providing a simple method for in-situ producing a novel solid catalyst component having unique performance and uniform distribution of active species formed on support particle that achieves excellent ethylene polymerization activity and superior hydrogen response and better operability during homo-polymerization or co-polymerization. It is desirable to utilize this in-situ process whereby a transition metal is deposited on the support during the reaction that generates the support for uniform distribution of active species formed on support particle, and provide a catalyst system suitable for both gas phase and slurry polymerization, especially in bimodal slurry polymerization for pipe production.

### SUMMARY OF THE INVENTION

The present invention relates to a process for preparing a solid catalyst component containing Mg. Ti, and internal electron donor in-situ produced therein, suitable for producing polyethylene and its copolymers, with said process having a combination of high productivity and high bulk density of ethylene polymers, lower soluble fraction, uniform particle morphology, and adjustable control of molecular weight distribution to allow controlled improvement in product properties as per specific requirements. The present invention further relates to a process for producing polyethylene and its copolymers in the presence of the solid catalyst component and a co-catalyst.

The process for preparing a solid catalyst component suitable for producing polyethylene and its copolymers generally comprises the steps of:
(i) contacting an acyl halide compound of the general formula RCOX, in which R is a linear or branched C₁-C₂₀ alkyl or aromatic and X is independently a halogen, with a magnesium compound of the general formula R¹OMgOR² or R¹OMgX in which R¹ and R² are same or different alkyl groups having from 1 to 20 carbon atoms and X is a halogen;
(ii) contacting the reaction product in step (i) with and an alkanol of the general formula ROH in which R is a linear or branched C₁-C₂₀ alkyl or aromatic, and/or an alkanediol of the general formula Rₙ(OH)₂ in which n is 2 to 20, R is a linear or branched C₁-C₂₀ alkyl or aromatic, to form reaction product (A);
(iii) contacting the reaction product (A) with an organohalide compound or chlorinated epoxy compound, and organophosphorus compounds obtained from RₙPOX₃₋ₙ in which n is from 0 to 3 and R(s) is/are a linear or branched C₁-C₂₀ alkyl or aromatic and X is independently halogen, to form reaction product (B);
(iv) contacting the reaction product (B) with a titanium compound represented by the general formula TiXₙ(OR)₄₋ₙ in which R(s) is/are a linear or branched C₁-C₂₀ alkyl or aromatic, X(s) is/are independently halogen, and n is an integer of from 1 to 4, to obtain a reaction product (C);
(v) contacting the reaction product (C) with tetravalent titanium halide compound for 1-2 times at temperatures preferably 100 to 200° C., to form a reaction product (D); and (vi) optionally contacting the reaction product (D) with an alkyl aluminum halide compound represented by the formula AlRₙX₃₋ₙ, wherein R(s) is/are a linear or branched C₁-C₁₀ alkyl or aromatic, X(s) is/are independently halogen, and n is a value meeting the condition of 1<n≤3.

In accordance with one embodiment, the present invention provides a method for preparing a catalyst component by:
(i) contacting an acyl halide compound of the general formula Rₙ(COX)₂ in which n is 2 to 10, R is a substituted or non-substituted linear or branched C₁-C₂₀ alkyl or aromatic and X is independently a halogen, with a magnesium compound of the general formula R¹OMgOR² or R¹OMgX in which R¹ and R² are same or different alkyl groups having from 1 to 20 carbon atoms and X is a halogen, to form reaction product (A);
(ii) contacting the reaction product (A) with an organohalide or chlorinated epoxy compound, and oranophosphorus compounds obtained from RₙPOX₃₋ₙ, in which n is from 0 to 3 and R is a hydrocarbyl or acromatic having 1 to 20 carbon atoms and X is independently a halogen, to form reaction product (B);
(iii) contacting the reaction product (B) with a titanium compound represented by the general formula TiXₙ(OR)₄₋ₙ in which R is a linear or branched C₁-C₂₀ alkyl or aromatic, X is independently a halogen, and n is an integer of from 1 to 4, to obtain a solid product (C);
(iv) contacting the reaction product (C) with a tetravalent titanium halide compound for 1-2 times at temperatures preferably between about 100 to 200° C., to form a reaction product (D),
(v) optionally contacting the reaction product (D) with an alkyl aluminum halide compound represented by the formula AlRₙX₃₋ₙ, wherein R is a linear or branched C₁-C₁₀ alkyl or aromatic, X is independently a halogen, and n is a value meeting the condition of 1<n≤3.

It is a preferred aspect of the present invention that the process according to the steps listed above are performed without any additional and/or intermediate steps. It is an advantage of the present invention that the entire catalyst preparation process can be conducted in one vessel, thereby eliminating the solvent decanting, solvent filtering, and solvent washing steps used in the prior art. Also, lower levels of small polymer particles (“fines”) may be obtained by applying the process of the present invention, which has the advantage of maintaining continuity of the polymerization process by preventing static formation, sheeting, or fouling in the polymerization reactor.

In accordance with certain teachings of the present invention, by employing a solid catalyst component that shows a combination of high productivity and high bulk density of ethylene polymers and lower soluble fraction (less wax), copolymers may be obtained with better comonomer response and comonomer incorporation. The obtained higher catalyst productivity and higher bulk density ultimately reduces the catalyst costs in the production of ethylene polymers and copolymers. In addition, the higher catalyst productivity results in lower residual catalyst components, preventing discoloration and gel formation. The higher powder bulk density results in increased production rate and lower polymer production costs. The higher powder bulk density results also in decreased frequency required product removal from the reactor to maintain the reactor bed level, for example, a fluidized bed gas phase polymerization process, which leads to an increase in the efficiency of reactant gas conversion to product, easiness in controlling gas phase compositions, and ethylene-based product quality.

An additional advantage of the present invention is that the molecular weight distribution, defined as a ratio of the weight average molecular weight (Mw) and the number average molecular weight (Mn), determined by Gel Permeation Chromatography (GPC), is found to be readily varied in the range of about 3 to about 7, by applying the solid catalyst components of the present invention, while maintaining a combination of high catalyst productivity and high bulk density. This control of molecular weight distribution allows controlled improvement in product properties as per specific requirements. Narrow molecular weight distribution from about 3 to about 5 benefits high stiffness and improved tensile properties of films and low shrinkage in injection moulded products. Broader molecular weight distribution products of about 5.5 to about 7 can also be readily produced by the present invention.

Further advantages of the process according to the present invention include improved mechanical properties of the ethylene polymers and copolymers, particularly increased stiffness (resulting in improved conversion behavior and efficiency), increased impact resistance, tensile strength, and tensile elongation.

### DETAILED DESCRIPTION

The present invention relates to methods of making a polymerization catalyst component comprising a magnesium-based support, internal donors formed in situ, and a titanium compound. The catalyst utilizing the present catalyst component produces polyethylene and polyethylene copolymer in an improved manner and is compatible with existing production processes such as slurry and gas-phase polymerization.

The present invention provides a process for producing an olefin polymerization catalyst, prepared by reacting an alkoxymagnesium compound with an acyl halide and an alkanol or an alkanediol to form reaction product (A), reacting the reaction product (A) with an organohalide and organophosphorus compound to form reaction product (B), reacting the reaction product (B) with a halogen-containing titanium or vanadium compound to obtain a reaction product (C) of magnesium composite support, internal donors formed in situ, and titanium compound, and then mixing the reaction product (C) with an alkyl aluminum compound to form catalyst component.

The method for producing a solid catalyst component and catalyst system for polymerization of olefins according to the present invention will be described.

In the method for producing a solid catalyst component for polymerization of olefins, a magnesium compound used in present invention has the general formula R¹OMgOR² or R¹OMgX, wherein R¹ and R² are the same or different alkyl groups having from 1 to 20 carbon atoms and X is a halogen.

In preferred embodiments of the present invention, the magnesium compound having an alkoxy group is preferably dialkoxy magnesium. Examples of the dialkoxy magnesium can include one or more compounds selected from, but not limited to, dibutoxy magnesium, diethoxy magnesium, dipropoxy magnesium, dimethoxy magnesium, dipentoxy magnesium, diisooctoxy magnesium, ethoxymethoxy magnesium, ethoxybutoxy magnesium, ethoxypropoxy magnesium, and ethoxyisooctoxy magnesium. The dialkoxy magnesium may be used alone or in combination of two or more thereof. Diethoxy magnesium is the preferred magnesium compound.

The dialkoxy magnesium may be dialkoxy magnesium obtained by reacting magnesium metal with an alcohol in the presence of a halogen, a halogen-containing metal compound, or the like. The particles of the magnesium compound having an alkoxy group are in a granular or powdery form in a dry state when implementing the method for producing a solid catalyst component for olefin polymerization according to one embodiment of the invention. The dialkoxy magnesium may have an indefinite shape or a spherical shape. When the spherical dialkoxy magnesium is used, the resulting polymer powder has a better (more spherical) particle shape and a narrower particle size distribution. This makes it possible to improve the handling capability of the polymer powder produced during polymerization, and eliminate occurrence of clogging problems.

The particles of the magnesium compound having an alkoxy group are in a granular or powdery form in dry state. The shape thereof is usually a spherical shape, but is not necessarily required to be a true spherical shape and may be an ellipsoidal shape. The bulk specific gravity of the magnesium compound having an alkoxy group is preferably about 0.1 to 0.6 g/ml, more preferably about 0.2 to 0.5 g/ml, further preferably about 0.25 to 0.40 g/ml. The average particle size D50 (i.e., the particle size at 50% in the cumulative volume particle size distribution) of the dialkoxy magnesium, measured using a laser diffraction/scattering particle size distribution analyzer, is preferably about 1 to 200 μm, and more preferably about 5 to 150 μm. For the spherical dialkoxy magnesium, the average particle size is preferably about 1 to 100 μm, more preferably about 5 to 60 μm, and still more preferably about 10 to 50 μm.

It is preferable for the dialkoxy magnesium particles to have a narrow particle size distribution, a low fine particle content, and a low coarse particle content, as measured by a laser diffraction/scattering particle size distribution analyzer. More specifically, it is preferable that the content of fine dialkoxy magnesium particles equal to or smaller than 5 μm is about 20% or less, and more preferably about 10% or less. The content of coarse particles, equal to or larger than 100 μm, is 10% or less, and more preferably 5% or less. The particle size distribution with the ratio of D90/D10 of the spherical dialkoxy magnesium is preferably 3 or less, and more preferably 2 or less, wherein D90 is the particle size at 90% in the cumulative volume particle size distribution, and D10 is the particle size at 10% in the cumulative volume particle size distribution.

In the method for producing a solid catalyst component for polymerization of olefins, it is preferable that the magnesium compound be used in the form of a solution or a suspension when subjected to the reaction. When the magnesium compound is used in the form of a solution or a suspension, the reaction proceeds advantageously. When the magnesium compound is solid, the magnesium compound may be dissolved in a solvent that can dissolve the magnesium compound to prepare a magnesium compound solution, or may be suspended in a solvent to form a magnesium compound suspension. The saturated hydrocarbon solvent and the unsaturated hydrocarbon solvent used in the present invention include linear or branched aliphatic hydrocarbon compounds having a boiling point of about 50 to 200° C., such as hexane, heptane, decane, and methylheptane; alicyclic hydrocarbon compounds having a boiling point of about 50 to 200° C., such as cyclohexane, ethylcyclohexane, and decahydronaphthalene; and aromatic hydrocarbon compounds having a boiling point of about 50 to 200° C., such as toluene, xylene, and ethylbenzene. Among these, linear aliphatic hydrocarbon compounds and aromatic hydrocarbon compounds are preferred.

In the method for producing a solid catalyst component for polymerization of olefins, an acyl halide used in the present invention is an organic compound with the functional group —C(═O)X and has the general formula RCOX in which R is independently a linear or branched C₁-C₂₀ alkyl or aromatic having 1 to 20 carbon atoms, and X is halogen, preferably chlorine.

In preferred embodiments of the present invention, the acyl halide with the functional group —C(═O)X is preferably acyl chloride with the functional group —C(═O)Cl. Examples of the acyl chloride can include one or more compounds selected from, but not limited to, acyl chloride, acetyl chloride, acryloyl chloride, adipoyl chloride, anisoyl chloride, azelaoyl chloride, benzoyl chloride, bromodifluoroacetyl chloride, butyryl chloride, 2-methylbutanoyl chloride, chloroacetyl chloride, dichloroacetyl chloride, diethymalony dichloride, dimethymalony chloride, dimethylcarbamoyl chloride, 3,5-dinitrobenzoyl chloride, fluoroacetyl chloride, 2-furoyl chloride, glutaryl chloride, heptanoyl chloride, hexanoyl chloride, isobutyryl chloride, lauroyl chloride, malonyl chloride, methacryloyl chloride, octanoyl chloride, oxalyl chloride, pentanoyl chloride, phosgene, pimeloyl chloride, pivaloyl chloride, propionyl chloride, sebacoyl chloride, suberoyl chloride, succinyl chloride, terephthaloyl chloride, thioacyl chloride, trichloroacetyl chloride, 2,4,6-trichlorobenzoyl chloride, trifluoroacetyl chloride, trimellitic anhydride chloride, and 2,4,6-trichlorobenzoyl chloride.

In the method for producing a solid catalyst component for polymerization of olefins, an organohalide compound having the general formula RX may be used, wherein R is a linear or branched C₁-C₂₀ alkyl or aromatic having 1 to 20 carbon atoms, and X is halogen, preferably chlorine. The organohalide compound is preferably one or more compounds selected from, but not limited to, epichlorohydrin, alkyl chloride such as butyl chloride, and aryl chloride such as benzyl chloride.

In preferred embodiments of the present invention, the organophosphorus compound can include one or more compounds selected from, but not limited to, phosphoryl chloride (POCl₃), diphenylphosphinic chloride, methylphosphonic dichloride, methylenebis(phosphonic dichloride), methylphosphonyl dichloride, methylphosphonyl dichloride, https://en.wikipedia.org/wiki/Methylphosphonyl_dichloridephenylphosphonic dichloride, phenylphosphonic dichloride, diphenylphosphinic chloride, phenylphosphonic dichloride, phosphonic acid, (chlorophenylmethyl)-dimethyl ester, (2-chloroethyl)phosphonoyl dichloride, methylphosphonyl dichloride, methylenebis(phosphonic dichloride), chloromethylphosphonic dichloride, (2-chloroethyl)phosphonic dichloride, phosphinic acid chloride, phosphonic dichloride, chloridophosphate, chlorothiophosphate, diethyl phosphorochlodate, and tributyl phosphate.

According to a preferred embodiment of the present invention, alcohols can also be used to make the catalyst component either as a single compound or as combination with two or three compounds including, but not limited to, mono alcohol, diol, polyols, and the like. according to this teaching, the inclusion of alcohols makes the reaction more homogenous and produce more uniform distribution of the active site species on magnesium composite support.

In the method for producing a solid catalyst component for the polymerization of olefins, an alkanol having the general formula ROH is used in present invention, wherein R(s) is/are a linear or branched C₁-C₂₀ alkyl or aromatic. Typical monohydric alcohols include methanol, n-propanol, iso-propanol, n-butanol, iso-butanol, sec-butanol, tert-butanol, n-amyl alcohol, iso-amyl alcohol, sec-amyl alcohol, tert-amyl alcohol, diethyl carbinol, sec-isoamyl alcohol, tert-butyl carbinol, hexanol, 2-ethyl-1-butanol, 4-methyl-2-pentanol, 1-heptanol, 2-heptanol, 4-heptanol, 2,4-dimethyl-3-pentanol, 1-octanol, 2-octanol, 2-ethyl-1-hexanol, 1-nonanol, 5-nonanol, diisobutylcarbinol, 1-decanol, 2,7-dimethyl-2-octanol, n-i-undecanol, n-i-dodecanol, n-i-heptadecanol, and n-i-octadecanol.

In a preferred aspect of the present invention, the alkanol may be an alcohol which comprises in addition to the hydroxyl moiety at least one further oxygen bearing group being different to a hydroxyl moiety. Preferably such further oxygen bearing group is an ether moiety. This kind of alcohol may be aliphatic or aromatic although aliphatic compounds are preferred. The aliphatic compounds may be linear, branched or cyclic or any combination thereof and in particular preferred alcohols are those comprising one ether moiety. Examples of such ether moiety containing alcohol include, but are not limited to, ethylene glycol butyl ether, ethylene glycol hexyl ether, ethylene glycol 2-ethylhexyl ether, 1,3-propylene glycol n-butyl ether, propylene glycol methyl ether, 1,3-propylene glycol ethyl ether, propylene glycol n-hexyl ether, and propylene glycol 2-ethylhexyl ether.

In the method for producing a solid catalyst component for polymerization of olefins, an alkanediol having the general formula Rₙ(OH)₂ is used in present invention, wherein n is 2 to 20, and R(s) is/are a linear or branched C₁-C₂₀ alkyl or aromatic. In general, the alkanediol is a diol or glycol, which a chemical compound containing two hydroxyl groups (—OH groups), such as geminal diols, vicinal diols, 1,3-diols, 1,4-diols, 1,5-diols, and longer diols. Vicinal diols have hydroxyl groups attached to adjacent atoms. Examples of preferred vicinal diol compounds are ethylene glycol and propylene glycol. Geminal diols have hydroxyl groups bonded to the same atom. However, carbonic acid ((HO)₂C═O) is unstable and has a tendency to convert to carbon dioxide (CO₂) and water (H₂O).

In preferred embodiments of the present invention, the alkanediols or diols include one or more compounds selected from, but not limited to, 1,2-ethanediol, 1,2-cyclohexanediol, 5-tert-butyl-3-methylbenzene-1,2-diol, 2-methyl-2-propyl-1,3-propanediol and neopentyl glycol (2,2-dimethylpropane-1,3-diol), 4-methyl-1-phenylpentane-1,3-diol, 4-methylcyclopentane-1,3-diol, 2,2-Dimethoxypropane-1,3-diol, 1,3-butylene glycol or butane-1,3-diol, 1,3-propanediol, 2,2,4-trimethylpentane-1,3-diol, 1,3-cyclohexanediol, 2-Ethylhexane-1,3-diol, 2,4-pentanediol, 1,4-pentanediol, 1,4-butanediol, 1,5-pentanediol, 1,6-hexanediol, and 1,10-decanediol.

In the method for producing a solid catalyst component for polymerization of olefins according to the present invention, a titanium compound represented by the general formula TiXₙ(OR)₄₋ₙ is employed, wherein R(s) is/are a linear or branched alkyl group having from 1 to 20 carbon atoms, X(s) is/are halogen, and n is an integer of from 1 to 4.

In the titanium compound represented by the general formula TiXₙ(OR)₄₋ₙ, examples of the halogen atom X include a fluorine atom, a chlorine atom, a bromine atom and an iodine atom. R is a linear or branched alkyl group having 1 to 20 carbon atoms, preferably an alkyl group having 1 to 7 carbon atoms, more preferably an alkyl group having 1 to 4 carbon atoms. Specific examples of R can include a methyl group, an ethyl group, a propyl group, an isopropyl group, a n-butyl group, an isobutyl group, a tert-butyl group, a n-pentyl group, an isopentyl group, a neopentyl group, a hexyl group and an isohexyl group.

Examples of the titanium compound represented by the general formula TiXₙ(OR)₄₋ₙ specifically include titanium tetra-halides such as titanium tetrachloride, titanium tetrabromide and titanium tetraiodide, and alkoxy titanium halides such as methoxy titanium trichloride, ethoxy titanium trichloride, propoxy titanium trichloride, butoxy titanium trichloride, dimethoxy titanium dichloride, diethoxy titanium dichloride, dipropoxy titanium dichloride, dibutoxy titanium dichloride, trimethoxy titanium chloride, ethoxy titanium trichloride, tripropoxy titanium chloride, tributoxy titanium chloride, and tetraalkoxytitaniums such as Ti(OCH₃)₄, Ti(OC₂H₅)₄, Ti(O-n-C₄H₉)₄, Ti(O-iso-C₄H₉)₄ and Ti(O-2-ethylhexyl)₄, and other compounds such as Ti[O—C(CH₃)CH—CO—CH]₂Cl₂, Ti[N(C₂H₅)₂]Cl₃, Ti[N(C₆H₅)₂]Cl₃, Ti(C₆H₅COO)Cl₃, [N(C₄H₉)₄]₂TiCl₆, [N(CH₃)₄]Ti₂Cl₉, TiBr₄, TiCl₃OSO₂C₆H₅, and LiTi(OC₃H₇)₂Cl₃.

The titanium compound represented by the general formula TiXₙ(OR)₄₋ₙ is preferably titanium tetrahalide, preferably titanium tetrachloride.

The titanium compound represented by the general formula TiXₙ(OR)₄₋ₙ may be used alone or in combination of two or more thereof, and diluted with a hydrocarbon compound or a halogenated hydrocarbon compound.

In accordance with one embodiment, the method for producing a solid catalyst component for polymerization of olefins according to the present invention comprises the step of bringing the magnesium compound having an alkoxy group, and the acyl halide or the acyl halide/alkanol mixture or the acyl halide/alkanediol mixture or the combination of acyl halide/alkanol/alkanediol into contact with each other to form reaction products (A), wherein for the contact between the magnesium compound having an alkoxy group and the acyl halide or the acyl halide/alkanol mixture or the acyl halide/alkanediol mixture or the combination of acyl halide/alkanol/alkanediol, the magnesium compound having an alkoxy group is slowly added to the acyl halide or the acyl halide/alkanol mixture or the acyl halide/alkanediol mixture or the combination of acyl halide/alkanol/alkanediol at a temperature from 20° C. to 120° C., preferably from 40° C. to 80° C., or alternatively the acyl halide or the acyl halide/alkanol mixture or the acyl halide/alkanediol mixture or the combination of acyl halide/alkanol/alkanediol is slowly added to the magnesium compound having an alkoxy group continuously or intermittently over 1 hours or longer. The reaction mixture was continuously stirred at a temperature from 40° C. to 120° C., preferably from 60° C. to 80° C., for over 3 hours or longer until the peak of acyl halide disappeared as monitored with GC-MS.

In accordance with one embodiment, the method for producing a solid catalyst component for polymerization of olefins according to the present invention comprises the step of bringing the reaction product (A), and an organochlorine compound such as epichlorohydrin and organophosphorus compound such as tributylphosphate into contact with each other to form reaction products (B), wherein for the contact between the reaction product (A) and the organochlorine compound and oranophosphorus compound, the reaction product (A) is slowly added to the organochlorine compound and organophosphorus compound at a temperature from 20° C. to 100° C., preferably from 40° C. to 60° C., or alternatively the organochlorine compound and organophosphorus compound is slowly added to the reaction product (A) continuously or intermittently over 1 hours or longer. The reaction mixture was continuously stirred at a temperature from 20° C. to 100° C., preferably from 40° C. to 60° C., for over 1.5 hours or longer.

In accordance with one embodiment, the method for producing a solid catalyst component for polymerization of olefins according to the present invention comprises the step of bringing the reaction product (A) or the reaction product (B), and the tetravalent titanium halide compound into contact with each other at low temperature in the presence of the inert organic solvent. The tetravalent titanium halide compound is slowly added to the reaction product (A) or reaction product (B) at a temperature lower than the reaction temperature. The low-temperature aging treatment brings the components including reaction product (A) or reaction product (B) and tetravalent titanium halide compound into contact each other at a temperature lower than the reaction temperature. The cooling temperature of components contact each other is preferably −40 to 20° C., more preferably −30 to 10° C., still more preferably −20 to 0° C. The low-temperature aging time is preferably 10 minutes to 2 hours, more preferably 30 minutes to 1 hour.

To produce catalyst component or reaction product (C), the reaction temperature between reaction product (A) or reaction product (B) and tetravalent titanium halide compound is preferably 0 to 130° C., more preferably 40 to 130° C., still more preferably 50 to 120° C., and most preferably 100 to 120° C. The reaction time is preferably 1 minute or more, more preferably 30 minutes or more, still more preferably 1 hour to 6 hours, still more preferably 1 hour to 4 hours, and most preferably 2 hours to 4 hours.

After completion of the reaction, it is preferable to wash the reaction product after allowing the reaction mixture to stand, appropriately removing the supernatant liquid to achieve a wet state (slurry state). The slurry reaction product is washed using the inert organic solvent (washing agent). The washing agent (solvent) is preferably one or more compounds selected from linear aliphatic hydrocarbon compounds (i.e., hexane, heptane and decane), alicyclic hydrocarbon compounds (i.e., methylcyclohexane and ethylcyclohexane), and aromatic hydrocarbon compounds (i.e., toluene, xylene, ethylbenzene, and o-dichlorobenzene). The reaction product is preferably washed at 0 to 120° C., more preferably 30 to 110° C., more preferably 50 to 110° C., still more preferably 80 to 110° C., and most preferably 100 to 110° C.

When implementing the method for producing a catalyst component (C) for olefin polymerization according to one embodiment of the invention, it is preferable to wash the reaction product by adding the desired amount of washing agent to the reaction product, stirring the mixture, and removing the liquid phase using a filtration method or a decantation method. Through washing process, it is highly possible to remove unreacted raw material components, reaction by-products (e.g., alkoxytitanium halide and titanium tetrachloride-carboxylic acid complex, if any), and impurities. The reaction product may be washed many times at more preferable temperature 100 to 110° C. The reaction product is preferably washed 1 to 15 times, more preferably 2 to 10 times, and still more preferably 2 to 5 times.

In the method for producing a reaction product (D) for polymerization of olefins according to one embodiment of the invention, a post-treatment may be appropriately performed by a tetravalent titanium halide compound after washing the reaction product (C). More specifically, a tetravalent titanium halide compound may be brought into contact with the reaction product (C) obtained by the reaction, or the reaction product that has been washed, or the reaction product may be washed after bringing a tetravalent titanium halide compound into contact with the reaction product (C). Post-treatment reaction temperature between reaction product (C) and tetravalent titanium halide compound is preferably 0 to 130° C., more preferably 40 to 130° C., still more preferably 50 to 120° C., and most preferably 100 to 120° C. The post-treatment reaction time is preferably 1 minute or more, more preferably 30 minutes or more, still more preferably 1 hour to 6 hours, still more preferably 1 hour to 4 hours, and most preferably 2 hours to 4 hours. The reaction product may be washed after or during the post-treatment in the same manner as described above.

When implementing the method for producing a catalyst component for olefin polymerization according to one embodiment of the invention, the reaction product (D) subjected to the post-treatment may be subjected to the second post-treatment reaction. The second post-treatment reaction between the reaction product (D) with tetravalent titanium halide compound is conducted in the same manner as explicated in the first post-treatment step. The final reaction product (D) may be washed after or during the second post treatment in the same manner as described in the first post treatment.

The olefin polymerization catalyst component according to one embodiment of the invention is produced by bringing the reaction product (D) and an organoaluminum halide compound represented by the following general formula AlRₙX₃₋ₙ into contact with each other.

Specific examples of the organoaluminum halide compound represented by the formula AlRₙX₃₋ₙ, wherein R(s) is/are a linear or branched C₁-C₁₀ alkyl or aromatic, X(s) is/are independently halogen, and n is a value meeting the condition of 1<n≤3, include one or more compounds selected from dimethylaluminum chloride, methylaluminum dichloride, diethylaluminum chloride, ethylaluminum dichloride, diethylaluminum bromide, and trioctylaluminum. Among these, dimethylaluminum chloride, and diethylaluminum chloride are preferable. The organoaluminum compound is used in a molar ratio of from 1 to 1000 per atom of titanium in the catalyst component.

The method for producing a solid catalyst component for polymerization of olefins according to the present invention is unique and different from the methods described in the prior art for propylene polymerization. In the prior art, to prepare catalyst components for olefin polymerization, especially for propylene polymerization, internal donor compound must be directly added during the preparation of catalyst component to improve the catalyst performance such as catalyst activity, molecular weight and molecular weight distribution, commoner incorporation, and short/long chain branching distribution. In general, the process in the prior art is to bring the magnesium compound, the tetravalent titanium halide compound, and internal electron donor compound into contact with each other to form the solid catalyst component. A second step may be used for finalizing catalyst component. In the second step included in the method for producing a solid catalyst component, the tetravalent titanium halide compound and one or more second internal electron donor compound (same to or different from internal donor used in first step) are brought into contact with the product obtained by the first step to finalize a reaction, followed by washing. A third step may also be applied to treat product obtained in send step by adding the tetravalent titanium halide compound and one or more second internal electron donor compound (same to or different from internal donor used in first/second step). Examples of internal electron donor compound used in the prior art includes phthalates, polycarboxylic acid ester, carboxylic acid ester, diol esters, diethers, and succinates as described in U.S. Pat. Nos. 4,107,414, 4,186,107, 4,226,963, 4,347,160, 4,382,019, 4,435,550, 4,465,782, 4,530,912, 4,532,313, 4,560,671, 4,657,882, 5,106,807, 5,208,302, 5,723,400, 5,902,765, 5,948,872, 6,121,483, 6,436,864, 6,605,562, 6,770,586, 6,683,017, 6,818,583, 6,822,109, 6,825,309, 7,022,640, 7,049,377, 7,202,314, 7,208,435, 7,223,712, 7,324,431, 7,351,778, 7,371,802, 7,388,061, 7,420,021, 7,491,781, 7,544,748, 7,674,741, 7,674,943, 7,888,437, 7,888,438, 7,964,678, 8,003,558, 8,003,559, 8,088,872, 8,211,819, 8,222,357, 8,227,370, 8,236,908, 8,247,341, 8,263,520, 8,263,692, 8,288,304, 8,288,585, 8,318,626, 8,383,540, 8,470,941, 8,536,290, 8,569,195, 8,575,283, 8,604,146, 8,633,126, 8,692,927, 8,664,142, 8,680,222, 8,716,417, 8,716,514, 8,740,947, 9,156,927, 9,790,291, 9,815,918, and 9,815,920, which are each incorporated in their entirety by reference herein.

In the method for producing a solid catalyst component for polymerization of olefins according to one embodiment of the invention, internal electron donor compounds reported in the prior art, including phthalates, polycarboxylic acid ester, carboxylic acid ester, diol esters, diethers, and succinates, are not directly used in the present invention, although it cannot be ruled out that such internal donor compounds or similar electron donors may be produced in-situ during the process of reaction in the present invention. It is believed, from the chemistry standpoint, that the method demonstrated in the present invention can potentially in-situ form electron donors or internal electron donor intermediates and create strong synergies having superior catalytic performance much higher than those reported in the prior art, as demonstrated in the Examples. In addition, it is noted that the inventive method can provide a novel solid catalyst component having unique performance and uniform distribution of the active species formed on support particle that achieves excellent olefin polymerization activity and higher hydrogen response and excellent reactor operability during homopolymerization or copolymerization with other olefins, and can produce polyethylene and its copolymers that exhibits a high MFR, lower solvent extractable, less static, and better comonomer incorporation.

The olefin polymerization catalyst system according to one embodiment of the invention is produced by bringing the catalyst component prepared above and cocatalysts such as an organoaluminum compound represented by the following general formula AlRₙX₃₋ₙ into contact with each other. Specific examples of the organoaluminum compound represented by the general formula AlRₙX₃₋ₙ, wherein R(s) is/are a linear or branched C₁-C₁₀ alkyl or aromatic, X(s) is/are independently halogen, and n is a value meeting the condition of 1<n≤3, include one or more compounds selected from triethylaluminum, diethylaluminum chloride, triisobutylaluminum, diethylaluminum bromide, trioctylaluminum, and diethylaluminum hydride. Among these, triethylaluminum and triisobutylaluminum are preferable. The organoaluminium compound is used in a molar ratio of from 1 to 1000 per atom of titanium in the catalyst component.

The olefin polymerization catalyst according to one embodiment of the invention may be obtained by bringing the solid catalyst component, the organoaluminum compound, and/or the external electron donor compound into contact each other. It is preferable that the order of contact with each other follows organoaluminum compound, solid catalyst component, and/or external electron donor compound. The olefin polymerization catalyst in present invention thus provides excellent olefin polymerization activity and superior hydrogen response, and produces an olefin polymer having high MFR and less wax.

The olefin may be homo-polymerized, or co-polymerized with another olefin. The olefin that is polymerized using the inventive catalyst component or olefin polymerization catalyst may be one or more olefins selected from ethylene, propylene, 1-butene, 1-pentene, 4-methyl-1-pentene, 1-hexene, and the like. Ethylene may be copolymerized with another olefin to produce MDPE and LLDPE polymer. Among these, ethylene, propylene, 1-butene, and 1-hexene are preferred, and ethylene is more preferred.

The olefin may be polymerized using olefin polymerization catalyst according to one embodiment of the invention in the presence or absence of an organic solvent. The olefin may be polymerized in a gaseous state or a liquid sate. A continuous polymerization process or a batch polymerization process may be used. The olefin may be polymerized in a single step or may be polymerized in two or more steps.

Examples of polymerization process include a slurry polymerization method that utilizes an inert hydrocarbon solvent such as heptane or cyclohexane, a bulk polymerization method that utilizes a solvent such as liquefied propylene, and a gas-phase polymerization method in which a solvent is not substantially used. Among these, a slurry polymerization method and a gas-phase polymerization method are preferable.

The components of the olefin polymerization catalyst according to one embodiment of the present invention may be brought into contact with the olefin in an arbitrary order. It is preferable to add the organoaluminum compound to a polymerization system that contains an inert gas atmosphere or an olefin gas atmosphere, add the solid catalyst component for olefin polymerization system, and bring one or more olefins into contact with the mixture. It is also preferable to add the organoaluminum compound to a polymerization system that contains an inert gas atmosphere or an olefin gas atmosphere, add the external electron donor compound to the polymerization system, add the solid catalyst component for olefin polymerization system, and bring one or more olefins into contact with the mixture.

When implementing the process for producing an olefin polymer according to one embodiment of the present invention, the polymerization temperature is normally 200° C. or less. The polymerization temperature is preferably 100° C. or less, more preferably 60 to 100° C., and most preferably 70 to 90° C., from the viewpoint of improving activity. When implementing the process for producing an olefin polymer according to one embodiment of the present invention, the polymerization pressure is preferably 10 MPa or less, and more preferably 5 MPa or less.

The molecular weight of the polymers may be controlled by known methods, preferably by using hydrogen. With the catalyst component produced according to the present invention, molecular weight may be suitably controlled with hydrogen when the polymerization is carried out at relatively low temperatures, e.g., from about 30° C. to about 105° C. This control of molecular weight may be evidenced by a measurable positive change of the Melt Flow Rate (MFR).

IN yet another embodiment of the present invention, a process for producing a solid catalyst component suitable for producing polyethylene and ethylene copolymers, said process comprising the steps of: (a) contacting an acyl halide compound with a magnesium compound to form a reaction product; (b) contacting the reaction product of step (a) with and an alkanol to form reaction product (A); (c) contacting the reaction product (A) with a compound selected from an organohalide compound or a chlorinated epoxy compound, and an organophosphorus compound to form reaction product (B); (d) contacting the reaction product (B) with a titanium compound to form reaction product (C); (e) contacting the reaction product (C) with a tetravalent titanium halide compound to form reaction product (D), wherein reaction product (D) comprises an internal electron donor produced in-situ; and, optionally, (f) contacting the reaction product (D) with an alkyl aluminum halide compound to form a reaction product (E), wherein reaction product (E) comprises the internal electron donor produced in-situ. The alkyl aluminum halide compound is represented by the formula AlRₙX₃₋ₙ, wherein R is a linear or branched C1-C10 alkyl or aromatic, wherein X is independently a halogen, and wherein n is an integer meeting the condition of 1<n≤3. The acyl halide compound is represented by the formula RCOX, wherein R is a linear or branched C1-C20 alkyl or aromatic, and wherein X is a halogen. The acyl halide compound is represented by the formula Rₙ(COX)₂, wherein n is an integer in the range of 2 to 10, wherein R is a substituted or non-substituted linear or branched C1-C20 alkyl or aromatic, and wherein X is a halogen. The magnesium compound is represented by the formula R¹OMgOR², wherein R¹ and R² are the same or different alkyl groups having from 1 to 20 carbon atoms, and wherein X is a halogen. The magnesium compound is represented by the R¹OMgX, wherein R¹ is an alkyl group having from 1 to 20 carbon atoms, and wherein X is a halogen. The alkanol is represented by the formula ROH, wherein R is a linear or branched C1-C20 alkyl or aromatic, and wherein the alkanol may be an alkanediol represented by the formula Rₙ(OH)₂, wherein n is an integer in the range of 2 to 20, and wherein R is a linear or branched C1-C20 alkyl or aromatic. The organophosphorus compound is represented by the formula RₙPOX₃₋ₙ, wherein n is an integer in the range of 0 to 3, wherein R is a linear or branched C1-C20 alkyl or aromatic, and wherein X is a halogen. The titanium compound is represented by the formula TiXₙ(OR)₄₋ₙ, wherein R is a linear or branched C1-C20 alkyl or aromatic, wherein X is a halogen, and wherein n is an integer in the range of 1 to 4. The molar ratio of the acyl halide compound to the magnesium compound is from about 0.1 to about 10. The molar ratio of the alkanol compound to the magnesium compound is from about 0.1 to about 10. The molar ratio of the organohalide compound or chlorinated epoxy compound to organophosphorus compound is from about 0.01 to about 5. The molar ratio of the compound selected from an organohalide compound or a chlorinated epoxy compound, and the organophosphorus compound, to the magnesium compound is from about 0.01 to about 5. The molar ratio of the titanium compound to the magnesium compound is from about 0.01 to about 10. The molar ratio of the alkyl aluminum halide compound to the magnesium compound is from about 0.01 to about 5.

The present invention is further described below by the way of examples. Note that the following examples are for illustrative proposes only, and the invention is not limited to the following examples.

### EXAMPLES

EDTA titration method was used to determine the content of magnesium in the solid catalyst component: The slurry catalyst component was dried under reduced pressure to completely remove solvent. The dried solid catalyst component was weighed and dissolved in a hydrochloric acid solution. After the addition of methyl orange (indicator) and a saturated ammonium chloride solution, the mixture was neutralized with aqueous ammonia, heated, cooled, and filtered to remove a precipitate (titanium hydroxide). A given amount of the filtrate was isolated, and heated. After adding a buffer and an EBT mixed indicator, the filtrate was titrated using an EDTA solution to determine the content of magnesium in the solid catalyst component.

Oxidation-reduction titration was used to determine the content of titanium in the solid catalyst component. Halogen content was determined by using an automatic titration device. The slurry catalyst component was dried under reduced pressure to completely remove solvent. The dried solid catalyst component was weighed, treated with a mixture of sulfuric acid and purified water to obtain an aqueous solution. A given amount of the aqueous solution was isolated, and titrated with a silver nitrate standard solution.

GC/MS was used to characterize, determine and monitor the changes of compounds and reaction progress. The instrument information is adopted here for reference. The GC/MS measurement (Gas Chromatograph with Mass Spectrometry) was from Agilent 7890B gas-chromatography, Agilent G4567A auto-injector and Agilent 5977A mass spectra detector.

The polymerization activity or productivity is calculated by mass (g) of polymer produced per gram of the solid catalyst component

The melt flow index (MI) (g/10 min) of the polymer was measured in accordance with ASTM D1238 at 190° C. with a load of 2.16 kg. Melt flow ratio (MFR), which is the ratio of high flow index (HLMI or I₂₁) to melt index (MI or I₂) was used as measure of melting fluidity and a measure of molecular weight distribution.

The molecular weight distribution (MWD) of the polymers prepared according to the present invention, as expressed by the MFR values, varies from about 10-40. The ethylene polymer having a density of about 0.930 g/ml to 0.970 g/ml, in a preferred embodiment, has a melt flow ratio (I₂₁/I₂) of between about 26 and 35. The ethylene/1-butene or 1-hexene copolymer having a density of about 0.910 g/ml to 0.930 g/ml, in a preferred embodiment, has a melt flow ratio (I₂₁I₂) of between about 20 and 30.

Molecular weight measurements were carried out using a high temperature size exclusion chromatograph (SEC) (Polymer Char) equipped with a differential refractive index (DRI) and infrared (IR) (PolyChar, IR4) detectors, a Viscotek model 210R viscometer, and a multi-angle laser light scattering (MALLS) apparatus (Wyatt, DAWN EOS). All measurements were taken at 145° C. using 1,2,4-trichlorobenzene (TCB) as the solvent. The system was calibrated with a standard material (NBS 1475) with a weight-average molecular weight of 52000 g/mol and an intrinsic viscosity of 1.01 dL/g. The refractive index increment, dn/dc, was calculated from the calibrated DRI detector as 0.11 mL/g. Molecular weights for the polyethylene polymers of the present invention were calculated from the intrinsic viscosity detector using the following Mark-Houwink parameters; K=4.5×10⁻⁴ dL/g and a=0.735, established for linear polyethylene from a polystyrene calibration.

Wax index was calculated based on the heptane soluble weight percentage (wt. %). 15-20 g of the completely dried polymer was extracted with refluxing heptane for 8 hours. The weight of insoluble polymer was collected and dried to calculate the heptane insoluble weight percentage (wt. %). The heptane soluble weight percentage (wt. %) was defined as wax index, which was obtained based on the difference between dried sample before extraction and heptane insoluble weight after extraction.

### Example 1

### (a) Preparation of a Solid Catalyst Component:

To a three-neck 250 ml flask equipped with a stirrer and thermometer, which was thoroughly purged with anhydrous nitrogen, 10.0 g of magnesium ethoxide and 80 ml of anhydrous toluene was introduced to form a suspension and the mixture was heated to gradually raise temperature to 60° C. 1.8 g isobutanol and 2.3 g phthaloyl chloride, dissolved in anhydrous toluene 15 ml, were slowly added through a stainless steel cannula. The mixture of magnesium ethoxide, phthaloyl chloride and isobutanol were stirred at 60° C. for 3 hours, which was monitored with GC-MS until the peak of phthaloyl chloride disappeared. The mixture was cooled to room temperature and kept overnight.

The mixture was cooled below −20° C. and 30 ml TiCl₄ was slowly added. The mixture was slowly heated to 80° C. and stirred for 2 hours. The hot mixture was transferred into a Schlenk type reactor equipped with a mechanical and a fritted filter disc, which was heated and maintained at the temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and then with anhydrous heptane twice at 90° C. and one time at ambient temperature. The final catalyst component was collected and dried under vacuum to obtain a solid composition.

### (B) Ethylene Slurry Polymerization

Ethylene was polymerized using a laboratory scale 2 liter stainless steel autoclave equipped with a stirrer and a jacket for heating and cooling, which was heated to a temperature above 100° C. to expel all traces of moisture and air with a nitrogen purge. After allowing the reactor to cool to 60° C. under nitrogen, one liter of anhydrous hexane was introduced into the autoclave. Autoclave temperature was elevated to 650 C, 1 mmol of triethyl aluminum and 20.0 mg of the solid catalyst obtained were added successively into the autoclave. Autoclave temperature was raised to 85° C. with stirring. The system, which was at a pressure of 29 psi (2 bar) from vapor pressure of the hexane with adjusting of nitrogen pressure, was pressurized with hydrogen to a total pressure of 85 psi and then followed ethylene to a total pressure of 145 psi to initiate polymerization.

The reaction was maintained for 1 hour under this condition with a continuous ethylene feed to maintain a constant total pressure during the course of the polymerization. After the reaction mixture was cooled below 50° C. and about 500 ml methanol was added into the mixture. After stirred for 10 minutes, the resulting polymer was separated by filtration and dried under reduced pressure at 80° C. for 5 hrs. The polymers were weighed and tested with melt flow rate (MFR) and Hexane Insoluble, listed in Table 1.

### Example 2

### (a) Preparation of a Solid Catalyst Component:

To a three-neck 250 ml flask equipped with a stirrer and thermometer, which was thoroughly purged with anhydrous nitrogen, 10.0 g of magnesium ethoxide and 80 ml of anhydrous toluene was introduced to form a suspension and the mixture was heated to gradually raise temperature to 80° C. 1.8 g isobutanol and 2.3 g phthaloyl chloride, dissolved in anhydrous toluene 10 ml, were slowly added through a stainless steel cannula. The mixture of magnesium ethoxide, phthaloyl chloride and isobutanol were stirred at 80° C. for 2 hours, which was monitored with GC-MS until the peak of phthaloyl chloride disappeared. The mixture was cooled to room temperature and kept overnight.

After the solution of 1.15 g epichlorohydrin and 3.0 g tributylphosphate, dissolved in anhydrous toluene 15 ml, were added into the mixture through a stainless steel cannula, the mixture was heated to 50° C., and stirred for 1.5 hours. The mixture was cooled below −20° C. and 30 ml TiCl₄ was slowly added. The mixture was slowly heated to 80° C. and stirred for 2 hours. The hot mixture was transferred into a Schlenk type reactor equipped with a mechanical and a fritted filter disc, which was heated and maintained at the temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and then with anhydrous heptane twice at 90° C. and one time at ambient temperature. The final catalyst component was collected and dried under vacuum to obtain a solid composition.

### (B) Ethylene Slurry Polymerization

Ethylene polymerization procedure of Example 2 was the same as described in Example 1. The polymers were weighed and tested with melt flow rate (MFR) and PE hexane insoluble (I %). The results were listed in Table 1.

### Example 3

The catalyst component was prepared by following the procedure of Example 2 except that 3.6 g isobutanol and 4.6 g phthaloyl chloride were used to react with 10.0 g of magnesium ethoxide at 60° C. and that 2.3 g epichlorohydrin and 6.0 g tributylphosphate was used. The final catalyst was collected and dried under vacuum to obtain a solid composition.

Ethylene slurry polymerization procedure of Example 3 was the same as described in Example 1. The polymers were weighed and tested with melt flow rate (MFR) and PE hexane insoluble (%). The results were listed in Table 1.

### Example 4

The catalyst component was prepared by following the procedure of Example 2 except that 0.46 g isobutanol and 2.5 g phthaloyl chloride were used to react with 10.0 g of magnesium ethoxide at 60° C. The final catalyst was collected and dried under vacuum to obtain a solid composition.

Ethylene slurry polymerization procedure of Example 4 was the same as described in Example 1. The polymers were weighed and tested with melt flow rate (MFR) and PE hexane insoluble (%). The results were listed in Table 1.

### Comparative Example 1

### (a) Preparation of a Solid Catalyst Component:

To a three-neck 250 ml flask equipped with a stirrer and thermometer, which was thoroughly purged with anhydrous nitrogen, 10.0 g of magnesium ethoxide and 100 ml of anhydrous toluene was introduced to form a suspension. 25 ml TiCl₄ was slowly added into the mixture at room temperature. The mixture was heated to gradually raise temperature to 45° C., and then 3.1 g diisobutyl phthalate was added. The temperature of mixture was slowly increased to 110° C. and maintained for 2 hours with stirring.

The hot mixture was transferred into a Schlenk type reactor equipped with a mechanical and a fritted filter disc, which was heated and maintained at the temperature 100° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The residual solid was filtered and washed with anhydrous toluene three times at 90° C., and then with anhydrous heptane twice at 90° C. and one time at ambient temperature. The final catalyst component was collected and dried under vacuum to obtain a solid composition.

### (B) Ethylene Slurry Polymerization

Ethylene polymerization procedure of Comparative Example 1 was the same as described in Example 1. The polymers were weighed and tested with melt flow rate (MFR) and PE hexane insoluble (%). The results were listed in Table 1.

### Example 5

### (a) Preparation of a Solid Catalyst Component:

To a three-neck 250 ml flask equipped with a stirrer and thermometer, which was thoroughly purged with anhydrous nitrogen, 10.0 g of magnesium ethoxide and 100 ml of anhydrous toluene was introduced to form a suspension and the mixture was heated to gradually raise temperature to 80° C. 1.15 g 2,4-pentane diol and 3.7 g benzoyl chloride, dissolved in anhydrous toluene 10 ml, were slowly added through a stainless steel cannula. The mixture of magnesium ethoxide, benzoyl chloride and 2,4-pentane diol were stirred at 80° C. for 10 minutes, and then stirred at 100° C. for 4 hours, which was monitored with GC-MS until the peak of benzoyl chloride disappeared. The mixture was cooled to room temperature and kept overnight.

The mixture was stirred at room temperature and 30 ml TiCl₄ was slowly added. The mixture was slowly heated to 100° C. and stirred for 2 hours. The hot mixture was transferred into a Schlenk type reactor equipped with a mechanical and a fritted filter disc, which was heated and maintained at the temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The residual solid was filtered and washed with anhydrous toluene three times at 90° C., and then with anhydrous heptane twice at 90° C. and one time at ambient temperature. The final catalyst component was collected and dried under vacuum to obtain a solid composition.

### (B) Ethylene Slurry Polymerization

Ethylene polymerization procedure of Example 5 was the same as described in Example 1. The polymers were weighed and tested with melt flow rate (MFR) and PE hexane insoluble (%). The results were listed in Table 1.

### Example 6

The catalyst component was prepared by following the procedure of Example 5 except that 1.15 g 2,4-pentane diol and 3.4 g benzoyl chloride were used to react with 10.0 g of magnesium ethoxide at 120° C. for 20 minutes. The final catalyst was collected and dried under vacuum to obtain a solid composition.

Ethylene slurry polymerization procedure of Example 6 was the same as described in Example 1. The polymers were weighed and tested with melt flow rate (MFR) and PE hexane insoluble (%). The results were listed in Table 1.

### Example 7

To a three-neck 250 ml flask equipped with a stirrer and thermometer, which was thoroughly purged with anhydrous nitrogen, 10.0 g of magnesium ethoxide and 80 ml of anhydrous toluene was introduced to form a suspension and the mixture was heated to gradually raise temperature to 60° C. 1.15 g 2,4-pentane diol and 3.3 g benzoyl chloride, dissolved in anhydrous toluene 10 ml, were slowly added through a stainless steel cannula. The mixture of magnesium ethoxide, 3.3 g benzoyl chloride and 2,4-pentane diol were stirred at 60° C. for 3 hours, which was monitored with GC-MS until the peak of benzoyl chloride disappeared. The mixture was cooled to room temperature and kept overnight.

The following procedure of Example 7 was the same as described in Example 2. The final catalyst was collected and dried under vacuum to obtain a solid composition.

Ethylene slurry polymerization procedure of Example 7 was the same as described in Example 1. The polymers were weighed and tested with melt flow rate (MFR) and PE hexane insoluble (%). The results were listed in Table 1.

### Example 8

The catalyst component was prepared by following the procedure of Example 7 except that except that 1.5 g 2,4-pentane diol and 4.3 g benzoyl chloride were used to react with 10.0 g of magnesium ethoxide at 50° C. for 6 hours. The final catalyst was collected and dried under vacuum to obtain a solid composition.

Ethylene slurry polymerization procedure of Example 8 was the same as described in Example 1. The polymers were weighed and tested with melt flow rate (MFR) and PE hexane insoluble (%). The results were listed in Table 1.

### Comparative Example 2

The catalyst component was prepared by following the procedure of Comparative Example 1 except that 3.2 g 2,4-pentanediol dibenzoate was added when the mixture was heated to gradually raise temperature to 40° C. The final catalyst was collected and dried under vacuum to obtain a solid composition.

Ethylene slurry polymerization procedure of Comparative Example 2 was the same as described in Example 1. The polymers were weighed and tested with melt flow rate (MFR) and PE hexane insoluble (%). The results were listed in Table 1.

### Example 9

### (a) Preparation of a Solid Catalyst Component:

To a three-neck 250 ml flask equipped with a stirrer and thermometer, which was thoroughly purged with anhydrous nitrogen, 10.0 g of magnesium ethoxide, 2.5 g diethylmalonyl dichloride and 100 ml of anhydrous toluene was introduced to form a suspension. The mixture was stirred at room temperature overnight, and then heated to 70° C. and stirred for 3 hours, which was monitored with GC-MS until the peak of diethylmalonyl dichloride. The mixture was stirred at 90° C. for 3 hours, and then stirred at 105° C. for 6 hours. The mixture was cooled to room temperature and kept overnight.

After the solution of 1.2 g epichlorohydrin and 3.1 g tributylphosphate, dissolved in anhydrous toluene 15 ml, were added into the mixture through a stainless steel cannula, the mixture was heated to 50° C., and stirred for 3 hours. The mixture was cooled in ice bath and 30 ml TiCl₄ was slowly added. The mixture was slowly heated to 80° C. and stirred for 2 hours. The hot mixture was transferred into a Schlenk type reactor equipped with a mechanical and a fritted filter disc, which was heated and maintained at the temperature 110° C. The resulting solid was filtered and washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and with anhydrous heptane twice at 90° C. and one time at ambient temperature. The final catalyst component was collected and dried under vacuum to obtain a solid composition.

### (B) Ethylene Slurry Polymerization

Ethylene polymerization procedure of Example 9 was the same as described in Example 1. The polymers were weighed and tested with melt flow rate (MFR) and PE hexane insoluble (%). The results were listed in Table 1.

### Comparative Example 3

The catalyst component was prepared by following the procedure of Comparative Example 1 except that 2.7 diethyl diethylmalonate was added instead of 3.1 g diisobutyl phthalate when the mixture was heated to gradually raise temperature to 80° C. The final catalyst was collected and dried under vacuum to obtain a solid composition.

Ethylene slurry polymerization procedure of Comparative Example 3 was the same as described in Example 1. The polymers were weighed and tested with melt flow rate (MFR) and PE hexane insoluble (%). The results were listed in Table 1.

### Example 10

The catalyst component was prepared by following the procedure of Example 9 except that only 1.8 g succinyl chloride instead of 2.5 g diethylmalonyl dichloride was used to react with 10.0 g of magnesium ethoxide at 50° C. for 4 hours. The final catalyst was collected and dried under vacuum to obtain a solid composition.

Ethylene slurry polymerization procedure of Example 10 was the same as described in Example 1. The polymers were weighed and tested with melt flow rate (MFR) and PE hexane insoluble (%). The results were listed in Table 1.

### Comparative Example 4

The catalyst component was prepared by following the procedure of Comparative Example 1 except that 1.9 g diethylsuccinate was added instead of 3.1 g diisobutyl phthalate when the mixture was stirred in ice bath during TiCl₄ adding. The final catalyst was collected and dried under vacuum to obtain a solid composition.

Ethylene slurry polymerization procedure of Comparative Example 4 was the same as described in Example 1. The polymers were weighed and tested with melt flow rate (MFR) and PE hexane insoluble (%). The results were listed in Table 1.

### Example 11

### (a) Preparation of a Solid Catalyst Component:

To a three-neck 250 ml flask equipped with a stirrer and thermometer, which was thoroughly purged with anhydrous nitrogen, 10.0 g of magnesium ethoxide and 50 ml of anhydrous toluene was introduced to form a suspension. 2.3 g 5-tert-butyl-3-methylbenzene-1,2-diol and 1.9 g benzoyl chloride, dissolved in anhydrous toluene 30 ml, were slowly added through a stainless steel cannula. The mixture was stirred at room temperature for 4.5 hours, which was monitored with GC-MS until the peak of benzoyl chloride disappeared. The mixture was gradually heated to 90° C. and stirred for 2.5 hours, and then 2.2 g benzoyl chloride was added. The mixture was stirred at 90° C. for 2 hours. The mixture was cooled to room temperature and kept overnight.

The mixture was cooled to room temperature and 20 ml TiCl₄ was slowly added. The mixture was slowly heated to 100° C. and stirred for 2 hours. The hot mixture was transferred into a Schlenk type reactor equipped with a mechanical and a fritted filter disc, which was heated and maintained at temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The mixture was filtered and the resulting solid washed twice with 40 ml of anhydrous toluene at 100° C. The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and then with anhydrous heptane twice at 90° C. and one time at ambient temperature. The final catalyst component was collected and dried under vacuum to obtain a solid composition.

### (B) Ethylene Slurry Polymerization

Ethylene polymerization procedure of Example 11 was the same as described in Example 1. The polymers were weighed and tested with melt flow rate (MFR) and PE hexane insoluble (%). The results were listed in Table 1.

### Example 12

The catalyst component was prepared by following the procedure of Example 11 except that the mixture of 1.8 g 5-tert-butyl-3-methylbenzene-1,2-diol and 1.9 g benzoyl chloride was added and the mixture was heated at 100° C. and stirred for 1 hour. The final catalyst was collected and dried under vacuum to obtain a solid composition.

Ethylene slurry polymerization procedure of Comparative Example 12 was the same as described in Example 1. The polymers were weighed and tested with melt flow rate (MFR) and PE hexane insoluble (%). The results were listed in Table 1.

### Example 13

The catalyst component was prepared by following the procedure of Example 11 except that the mixture of 1.8 g 5-tert-butyl-3-methylbenzene-1,2-diol and 3.1 g benzoyl chloride was added and the mixture was heated at 80° C. and stirred for 3 hour. The final catalyst was collected and dried under vacuum to obtain a solid composition.

Ethylene slurry polymerization procedure of Comparative Example 13 was the same as described in Example 1. The polymers were weighed and tested with melt flow rate (MFR) and PE hexane insoluble (%). The results were listed in Table 1.

### Example 14

### (a) Preparation of a Solid Catalyst Component:

To a three-neck 250 ml flask equipped with a stirrer and thermometer, which was thoroughly purged with anhydrous nitrogen, 10.0 g of magnesium ethoxide, 1.15 g 2,4-pentane diol and 80 ml of anhydrous toluene was introduced to form a suspension. The mixture was heated to 100° C. and the mixture of 2.44 g benzoyl chloride and 1.37 g diphenylphosphinic chloride dissolved in 30 ml toluene was added slowly. The mixture was stirred for 30 minutes at 100° C. and the mixture was cooled to room temperature and kept overnight.

The following procedure of Example 14 was same as the preparation of Example 11. The final catalyst was collected and dried under vacuum to obtain a solid composition.

### (B) Ethylene Slurry Polymerization

Ethylene polymerization procedure of Example 14 was the same as described in Example 1. The polymers were weighed and tested with melt flow rate (MFR) and PE hexane insoluble (%). The results were listed in Table 1.

### Example 15

### (a) Preparation of a Solid Catalyst Component:

To a three-neck 250 ml flask equipped with a stirrer and thermometer, which was thoroughly purged with anhydrous nitrogen, 10.0 g of magnesium ethoxide, 1.15 g 2,4-pentane diol and 80 ml of anhydrous toluene was introduced to form a suspension. The mixture was heated to 100° C. and 1.3 g diphenylphosphinic chloride dissolved in 10 ml toluene was added first. After the mixture was stirred at 100° C. for 5 minutes, 2.44 g benzoyl chloride was added. The mixture was stirred at 100° C. for 2 hours and was cooled to room temperature and kept overnight.

The following procedure of Example 15 was same as the preparation of Example 11. The final catalyst was collected and dried under vacuum to obtain a solid composition.

### (B) Ethylene Slurry Polymerization

Ethylene polymerization procedure of Example 15 was the same as described in Example 1. The polymers were weighed and tested with melt flow rate (MFR) and PE hexane insoluble (%). The results were listed in Table 1.

### Example 16

### (a) Preparation of a Solid Catalyst Component:

To a three-neck 250 ml flask equipped with a stirrer and thermometer, which was thoroughly purged with anhydrous nitrogen, 10.0 g of magnesium ethoxide, 1.55 g benzoyl dichloride and 100 ml of anhydrous toluene was introduced to form a suspension. The mixture was stirred at room temperature for 40 minutes, and then heated to 50° C. and stirred for 6 hours, which was monitored with GC-MS until the peak of benzoyl dichloride. The mixture was cooled to room temperature and kept overnight.

After the solution of 0.7 g epichlorohydrin and 1.7 g tributylphosphate, dissolved in anhydrous toluene 15 ml, were added into the mixture through a stainless steel cannula, the mixture was heated to 50° C., and stirred for 3 hours. The mixture was cooled in ice bath and 20 ml TiCl₄ was slowly added. The mixture was slowly heated to 105° C. and stirred for 3.5 hours. The hot mixture was transferred into a Schlenk type reactor equipped with a mechanical and a fritted filter disc, which was heated and maintained at the temperature 100° C. The resulting solid was filtered and washed twice with 40 ml of anhydrous toluene at 100° C. 80 ml of fresh anhydrous toluene and 5 ml TiCl₄ was added to the filtered solid, and then the mixture was heated to 107° C. and stirred for 1 hour.

The mixture was filtered and washed with anhydrous toluene three times at 90° C., and then with anhydrous heptane twice at 90° C. and one time at ambient temperature. The final catalyst component was collected and dried under vacuum to obtain a solid composition.

### (B) Ethylene Slurry Polymerization

Ethylene polymerization procedure of Example 16 was the same as described in Example 1. The polymers were weighed and tested with melt flow rate (MFR) and PE hexane insoluble (%). The results were listed in Table 1.

### Example 17

### (a) Preparation of a Solid Catalyst Component:

The catalyst component was prepared by following the procedure of Example 16 except that 0.7 g epichlorohydrin was added instead of the mixture of 0.7 g epichlorohydrin and 1.7 g tributylphosphate and the mixture was heated at 50° C. and stirred for 3 hours. The final catalyst was collected and dried under vacuum to obtain a solid composition.

### (B) Ethylene Slurry Polymerization

Ethylene slurry polymerization procedure of Example 17 was the same as described in Example 1. The polymers were weighed and tested with melt flow rate (MFR) and PE hexane insoluble (%). The results were listed in Table 1.

### Example 18

### (a) Preparation of a Solid Catalyst Component:

The catalyst component was prepared by following the procedure of Example 16 except that 2.5 g diethylmalonyl dichloride instead of 1.55 g benzoyl dichloride is added, and the mixture was heated to 105° C. and stirred for 5 hours, and 1.2 g epichlorohydrin were added instead of 0.7 g epichlorohydrin and 1.7 g tributylphosphate. The final catalyst was collected and dried under vacuum to obtain a solid composition.

### (B) Ethylene Slurry Polymerization

Ethylene slurry polymerization procedure of Example 18 was the same as described in Example 1. The polymers were weighed and tested with melt flow rate (MFR) and PE hexane insoluble (%). The results were listed in Table 1.

### Comparative Example 5

### (a) Preparation of a Solid Catalyst Component:

A solid catalyst precursor was prepared according to U.S. Pat. No. 4,748,221, French Patent No. 2,116,698, and European Patent No. 0,703,246 A1. Anhydrous hexane (2 L), magnesium (31.9 g), iodine (3.3 g), isopropanol (3.66 ml), and butyl chloride (2.8 ml) were successively charged into a 5 L reactor equipped with an anchor stirrer driven by a magnetic motor. The reactor was heated to 85° C. within 60 minutes and then cooled to 80° C. within 20 minutes. Ti(OPr)₄ (45.5 ml, 165.4 mmol) with TiCl₄ (18.3 ml, 166.0 mmol) was charged to the reactor, followed by the slow introduction over 4 hours of n-butyl chloride (213.3 ml, 2041.5 mmol) at 80° C. The mixture was stirred for a further 2 hours at 80° C., and then cooled to room temperature. The solid precipitate was washed 3 times with 2 L hexane to yield Comparative Catalyst 1. A gray solid magnesium-titanium catalyst precursor composition was obtained, which contains 8.0 wt % Ti, and 14.7 wt % Mg, respectively.

### (B) Ethylene Slurry Polymerization

Ethylene slurry polymerization procedure of Example 5 was the same as described in Example 1. The polymers were weighed and tested with melt flow rate (MFR) and PE hexane insoluble (%). The results were listed in Table 1.

TABLE 1
Ethylene slurry polymerizations

| | | | Hexane | | |
|---|---|---|---|---|---|
| | AC | MFR | Insoluble | Bulk | |
| Examples | (gPE/gCat) | (g/10 min) | (%) | Density | MWD |
| Ex. 1 | 5911.8 | 6.4 | 99.6 | 0.38 | 4.1 |
| Ex. 2 | 7113.3 | 8.0 | 99.8 | 0.39 | 3.8 |
| Ex. 3 | 4214.6 | 2.7 | 99.6 | 0.37 | 4.5 |
| Ex. 4 | 5217.8 | 9.3 | 99.6 | 0.36 | 4.2 |
| Ex. 5 | 7288.6 | 8.4 | 99.2 | 0.36 | 4.1 |
| Ex. 6 | 4519.6 | 9.4 | 99.7 | 0.37 | 4.2 |
| Ex. 7 | 9541.5 | 13.9 | 99.1 | 0.40 | 3.8 |
| Ex. 8 | 5098.5 | 11.6 | 98.7 | 0.37 | 4.3 |
| Ex. 9 | 8848.0 | 5.4 | 99.7 | 0.38 | 4.2 |
| Ex. 10 | 4828.4 | 3.5 | 99.8 | 0.37 | 5.0 |
| Ex. 11 | 6403.9 | 10.0 | 99.6 | 0.37 | 5.2 |
| Ex. 12 | 7644.2 | 9.6 | 99.4 | 0.38 | 5.1 |
| Ex. 13 | 8960.4 | 10.2 | 99.6 | 0.37 | 4.8 |
| Ex. 14 | 2990.2 | 15.4 | 99.8 | 0.36 | 7.0 |
| Ex. 15 | 5874.4 | 6.0 | 99.5 | 0.37 | 6.4 |
| Ex. 16 | 4465.7 | 9.6 | 99.2 | 0.38 | 6.1 |
| Ex. 17 | 5759.8 | 17.0 | 99.5 | 0.37 | 4.5 |
| Ex. 18 | 4839.0 | 5.3 | 99.6 | 0.37 | 4.3 |
| Comp. Ex. 1 | 3149.3 | 2.5 | 99.0 | 0.30 | 4.5 |
| Comp. Ex. 2 | 2512.3 | 6.2 | 99.7 | 0.35 | 4.8 |
| Comp. Ex. 3 | 1668.3 | 5.8 | 99.8 | 0.30 | 6.0 |
| Comp. Ex. 4 | 1872.6 | 4.3 | 99.3 | 0.30 | 6.5 |
| Comp. Ex. 5 | 1450.5 | 5.6 | 90.5 | 0.28 | 7.5 |

As demonstrated in Table 1, the catalyst preparation process of the present invention makes it possible to achieve polyolefin catalyst components having high activity and better operability to produce ethylene polymer with less wax (soluble fraction) and high powder bulk density. For examples, the catalyst component of Example 2 exhibited higher polymerization activity, higher heptane insoluble and bulk density comparing with Comparative Example 1. The similar results are also found between Example 7 and Comparative Example 2, Example 9 and Comparative Example 3, and Example 10 and Comparative Example 4. As such, the present inventive catalyst system offers more flexibility to the applications and a broader approach to preparing catalyst components for polyolefin production, which is useful in slurry polymerization for producing bimodal products and PE pipe products.

### Example 19

### (a) Preparation of a Solid Catalyst Component:

To a three-neck 250 ml flask equipped with a stirrer and thermometer, which was thoroughly purged with anhydrous nitrogen, 10.0 g of magnesium ethoxide and 50 ml of anhydrous toluene was introduced to form a suspension. 2.3 g 5-tert-butyl-3-methylbenzene-1,2-diol and 1.9 g benzoyl chloride, dissolved in anhydrous toluene 30 ml, were slowly added through a stainless steel cannula. The mixture was stirred at room temperature for 4.5 hours, which was monitored with GC-MS until the peak of benzoyl chloride disappeared. The mixture was gradually heated to 90° C. and stirred for 2.5 hours, and then 2.2 g benzoyl chloride was added. The mixture was stirred at 90° C. for 2 hours. The mixture was cooled to room temperature and kept overnight.

The mixture was cooled to room temperature and 20 ml TiCl₄ was slowly added. The mixture was slowly heated to 100° C. and stirred for 2 hours. The hot mixture was transferred into a Schlenk type reactor equipped with a mechanical and a fritted filter disc, which was heated and maintained at temperature 110° C. The resulting solid was filtered and washed twice with 40 ml of anhydrous toluene at 100° C. 80 ml of fresh anhydrous toluene and 25 ml TiCl₄ was added to the filtered solid and then the mixture was heated to 110° C. and stirred for 2 hours.

The mixture was further treated with 10 ml of dimethylaluminum chloride (1.0M) at 110° C. for 1 hour. The mixture was then filtered and the resulting solid washed twice with 40 ml of anhydrous toluene at 100° C. The mixture was filtered and the resulting solid washed twice with 40 ml of anhydrous toluene at 100° C. 80 ml of fresh anhydrous toluene and 25 ml TiCl₄ was added to the filtered solid, and then the mixture was heated to 110° C. and stirred for 2 hours.

The residual solid was filtered and washed with anhydrous toluene three times at 90° C., and then with anhydrous heptane twice at 90° C. and one time at ambient temperature. The final catalyst component was collected and dried under vacuum to obtain a solid composition.

### (B) Ethylene/Olefin Copolymerization

A 2.0-liter stainless steel autoclave under a slow nitrogen purge at 65° C. was filled with dry hexane (1000 ml). 1.7 ml of 1.0 M triethylaluminum and 20 mg of solid catalyst component (precursor) was successively introduced into the reactor at 65° C. The reactor was closed, the stirring was increased to 750 rpm, and the internal temperature was raised to 85° C. The internal pressure was increased to 37 psig with hydrogen (29 psi of nitrogen). 100 ml of 1-hexenes and ethylene were introduced to maintain the total pressure at about 90 psig. The co-polymerization was carried out immediately and continued at 85° C. for 60 minutes, and then the ethylene supply was stopped by adding methanol/HCl solution and reactor was allowed to cool. The copolymer was collected and dried under vacuum at 70° C. for 6 hours. The copolymer having good powder property was obtained for further physical tests including polymer soluble fraction (low molecular weight fraction or wax fraction), polymer density, melting flow index, and molecular weight distribution. The results were listed in Table 2.

### Examples 20-24

Examples 20-24 were conducted with the catalyst as described in Example 5, Example 7, Example 9, Example 12, Example 13, respectively.

Ethylene/olefin copolymerization was the same as described in Example 19. The copolymer having good powder property was obtained for further physical tests including polymer soluble (wax) fraction, polymer density, melting flow index, and molecular weight distribution. The results were listed in Table 2.

### Comparative Examples 6-10

### Ethylene/Olefin Copolymerization

Ethylene/olefin copolymerization procedure of Examples 6-10 was the same as described in Examples 19-23. The copolymer having good powder property was obtained for further physical tests including polymer soluble (wax) fraction, polymer density, melting flow index, and molecular weight distribution.

Comparative examples 6-10 were conducted with the catalyst as described in Comparative Example 1, Comparative Example 2, Comparative Example 3, Comparative Example 4, and Comparative Example 5, respectively. The results were listed in Table 2.

TABLE 2
Ethylene/1-Hexene co-polymerizations

| | | | | Hexane | |
|---|---|---|---|---|---|
| | AC | MFR | | soluble | |
| Examples | (gPP/gCat) | (g/10 min) | Density | (%) | MWD |
| Ex. 19 | 5548.2 | 2.5 | 0.9165 | 0.70 | 3.6 |
| Ex. 20 | 6288.6 | 8.4 | 0.9205 | 1.98 | 3.8 |
| Ex. 21 | 7541.5 | 7.9 | 0.9185 | 1.40 | 3.9 |
| Ex. 22 | 6848.0 | 5.4 | 0.9193 | 1.38 | 4.1 |
| Ex. 23 | 5644.2 | 9.6 | 0.9201 | 1.38 | 4.2 |
| Ex. 24 | 5960.4 | 8.2 | 0.9206 | 1.37 | 4.5 |
| Comp. Ex. 6 | 4149.3 | 2.5 | 0.9255 | 2.30 | 5.6 |
| Comp. Ex. 7 | 3912.3 | 6.2 | 0.9301 | 2.65 | 5.5 |
| Comp. Ex. 8 | 3668.3 | 5.8 | 0.9302 | 2.39 | 5.7 |
| Comp. Ex. 9 | 3872.6 | 4.3 | 0.9265 | 2.52 | 6.4 |
| Comp. Ex. 10 | 3450.5 | 5.6 | 0.9285 | 5.28 | 6.5 |

From Table 2 one can see that the polyolefin catalyst components prepared in the present invention shows high activity, better co-monomer response, less wax (soluble fraction), and narrow molecular weight distribution. The polyolefin catalyst components prepared in the present invention is also capable of producing MDPL and LLDPL products.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Whenever a numerical range with a lower limit and an upper limit is disclosed, any number falling within the range is specifically disclosed. Moreover, the indefinite articles “a” or “an”, as used in the claims, are defined herein to mean one or more than one of the element that it introduces.

What is claimed is:

1. A process for producing a solid catalyst component suitable for producing polyethylene and ethylene copolymers, said process comprising the steps of:
(a) contacting an acyl halide compound with a magnesium compound to form a reaction product;
(b) contacting the reaction product of step (a) with and an alkanol to form reaction product (A);
(c) contacting the reaction product (A) with a compound selected from an organohalide compound or a chlorinated epoxy compound, and an organophosphorus compound to form reaction product (B);
(d) contacting the reaction product (B) with a titanium compound to form reaction product (C);
(e) contacting the reaction product (C) with a tetravalent titanium halide compound to form reaction product (D), wherein reaction product (D) comprises an internal electron donor produced in-situ.

2. The process of claim 1, further comprising: (f) contacting the reaction product (D) with an alkyl aluminum halide compound to form a reaction product (E), wherein reaction product (E) comprises an internal electron donor produced in-situ.

3. The process of claim 1, wherein the alkyl aluminum halide compound is represented by the formula AlRₙX₃₋ₙ, wherein R is a linear or branched C₁-C₁₀ alkyl or aromatic, wherein X is independently a halogen, and wherein n is an integer meeting the condition of 1<n≤3.

4. The process of claim 1, wherein the acyl halide compound is represented by the formula RCOX, wherein R is a linear or branched C1-C20 alkyl or aromatic, and wherein X is a halogen.

5. The process of claim 1, wherein the acyl halide compound is represented by the formula Rₙ(COX)₂, wherein n is an integer in the range of 2 to 10, wherein R is a substituted or non-substituted linear or branched C1-C20 alkyl or aromatic, and wherein X is a halogen.

6. The process of claim 1, wherein the magnesium compound is represented by the formula R¹OMgOR², wherein R¹ and R² are the same or different alkyl groups having from 1 to 20 carbon atoms, and wherein X is a halogen.

7. The process of claim 1, wherein the magnesium compound is represented by the R¹OMgX, wherein R¹ is an alkyl group having from 1 to 20 carbon atoms, and wherein X is a halogen.

8. The process of claim 1, wherein the alkanol is represented by the formula ROH, wherein R is a linear or branched C1-C₂₀ alkyl or aromatic.

9. The process of claim 1, wherein the alkanol is an alkanediol represented by the formula Rₙ(OH)₂, wherein n is an integer in the range of 2 to 20, and wherein R is a linear or branched C₁-C₂₀ alkyl or aromatic.

10. The process of claim 1, wherein the organophosphorus compound is represented by the formula RₙPOX₃₋ₙ, wherein n is an integer in the range of 0 to 3, wherein R is a linear or branched C1-C₂₀ alkyl or aromatic, and wherein X is a halogen.

11. The process of claim 1, wherein the titanium compound is represented by the formula TiXₙ(OR)₄₋ₙ, wherein R is a linear or branched C₁-C₂₀ alkyl or aromatic, wherein X is a halogen, and wherein n is an integer in the range of 1 to 4.

12. The process of claim 1, wherein the molar ratio of the acyl halide compound to the magnesium compound is from about 0.1 to about 10.

13. The process of claim 1, wherein the molar ratio of the alkanol compound to the magnesium compound is from about 0.1 to about 10.

14. The process of claim 1, wherein the molar ratio of the organohalide compound or chlorinated epoxy compound to organophosphorus compound is from about 0.01 to about 5.

15. The process of claim 1, wherein the molar ratio of the compound selected from an organohalide compound or a chlorinated epoxy compound, and the organophosphorus compound, to the magnesium compound is from about 0.01 to about 5.

16. The process of claim 1, wherein the molar ratio of the titanium compound to the magnesium compound is from about 0.01 to about 10.

17. The process of claim 2, wherein the molar ratio of the alkyl aluminum halide compound to the magnesium compound is from about 0.01 to about 5.
